(19) United States
(12) Patent Application Publication
(10) Pub. No.: US 2007/0074209 A1
(43) Pub. Date: Mar. 29, 2007

(54) System for automatically designing software agents

(75) Inventors: Adam Jung, Owego, NY (US); John O. Moody, Vestal, NY (US); Robert J. Szczerba, Endicott, NY (US); Joel J. Tleon, Endicott, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Lockheed Martin Corporation

(21) Appl. No.: 11/188,680

(22) Filed: Jul. 25, 2005

(51) Int. Cl. G06F 9/46

(52) U.S. Cl. 718/100

(57) ABSTRACT

A system in accordance with the present invention automatically designs a software component to perform a defined task having task inputs and task outputs. The system includes a plurality of modules, a first comparator, a selector, and a second comparator. Each of the plurality of modules has module inputs and module outputs. The first comparator compares the module outputs to the task outputs. The first comparator determines whether the task outputs are achievable by the plurality of modules. The first comparator determines whether at least two of the plurality of modules satisfy one of the task outputs. The selector selects a preferred module from the at least two of the plurality of modules. The second comparator compares at least one of the task inputs to inputs of the preferred module. The second comparator determines whether the inputs of the preferred module are included within the task inputs. The first comparator receives inputs of the preferred module that are not included within the task inputs.

### FIELD OF INVENTION

The present invention relates to a system for automatically designing software agents and, more particularly, to a system for automatically designing software agents in real time.

### BACKGROUND OF THE INVENTION

Autonomous systems are required to adapt to a changing environment. Particularly, autonomous battle systems are required to adapt to rapidly changing environments since few environments change more rapidly than a battle space encountered during the fog of war and containing an adaptable enemy. Autonomous systems are required to have flexible and dynamic approaches to problem solving and decision-making.

Without this capability, autonomous systems are inadequately prepared or unprepared to process changes in the environment and may be incapacitated by these changes. Alternatively, these non-adaptive systems may be able to process only problems envisioned and solved at the time of original development of the systems, possibly years earlier. This may result not only in damage to or loss of these systems, but other systems dependent on them, or lives dependent on them.

Conventional control systems, and in particular, conventional military control systems have typically been conservatively designed for predictable behavior, i.e., every conceivable situation having a well-defined response behavior for the system. Another, less conservative, conventional approach is based on random perturbations measured against fitness functions, resulting in quasi-random, irreproducible behaviors generally undesirable for a control system.

The conservative approach limits behavior of a system to predefined situations conceived by the designers of the system. As a result, the conservative system requires a large amount of controlling element (i.e., a human user) intervention for unconceived situations or situations too complex for the brittle decision tree to handle.

The less conservative, or emergent, approach is equally undesirable in a control system. Rather than predictable behavior or quasi-random behavior, the changing battlefield environment requires constrained behavior. It is desirable for control systems to ensure that certain events do not happen, rather than that certain events do happen. The conventional approaches ensure that only certain events happen and that nothing else does happen.

### SUMMARY OF THE INVENTION

A system in accordance with the present invention automatically designs a software component to perform a defined task having task inputs and task outputs. The system includes a plurality of modules, a first comparator, a selector, and a second comparator. Each of the plurality of modules has module inputs and module outputs. The first comparator compares the module outputs to the task outputs. The first comparator determines whether the task outputs are achievable by the plurality of modules. The first comparator determines whether at least two of the plurality of modules satisfy one of the task outputs. The selector selects a preferred module from the at least two of the plurality of modules. The second comparator compares at least one of the task inputs to inputs of the preferred module. The second comparator determines whether the inputs of the preferred module are included within the task inputs. The first comparator receives inputs of the preferred module that are not included within the task inputs.

A computer program product in accordance with the present invention automatically designs a software component to perform a defined task having task inputs and task outputs. The computer program product includes a first instruction for comparing module outputs of a plurality of modules to the task outputs; a second instruction for determining whether the task outputs are achievable by the plurality of modules; a third instruction for determining whether at least two of the plurality of modules satisfy one of the task outputs; a fourth instruction for selecting a preferred module from the at least two of the plurality of modules; a fifth instruction for comparing at least one of the task inputs to inputs of the preferred module; a sixth instruction for determining whether the inputs of the preferred module are included within the task inputs; and a seventh instruction for communicating inputs of the preferred module that are not included within the task inputs.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of an example system in accordance with the present invention;

FIG. 2 is a schematic representation of part of an example system in accordance with the present invention;

FIG. 3 is a schematic representation of another part of an example system in accordance with the present invention;

FIG. 4 is a schematic representation of still another part of an example system in accordance with the present invention;

FIG. 5 is a schematic representation of yet another part of an example system in accordance with the present invention; and

FIG. 6 is a schematic representation of an example computer program product in accordance with the present invention.

### DESCRIPTION OF AN EXAMPLE EMBODIMENT

In order to achieve greater flexibility and adaptability, a system in accordance with the present invention may behave in ways not conceived by its designers. By uniquely utilizing software agents, the system may offer an approach more flexible than conventional approaches. Conventional agents seek to effect or prevent change in their environment based on their programming. Unlike agents of the system, conventional agents are nevertheless limited by their programming.

A system in accordance with the present invention may include planning agents designed on an ad-hoc basis. Whereas conventional software agents are instantiated based on pre-programmed behaviors, planning agents of the system may be designed on an ad-hoc basis using preprogrammed modules.

These preprogrammed modules may be characterized a priori. Characteristics may then be matched to given objectives and constraints of the planning agent and combined, or “strung together”, to form a planning agent design. Thus, planning agents may be designed based on a current situation, objectives, and constraints, rather than those at the time of development. The system thereby offers superior performance in a rapidly changing environment.

The ad hoc design of the planning agents allows the system to decompose algorithms into modules, or “primitives”. Primitives may be building blocks for algorithms from which the primitives were derived, as well for new, superior algorithms. This modularity facilitates reuse of the primitives for increased efficiency and rapid prototyping. The system may collect, or group, the modules into a module library.

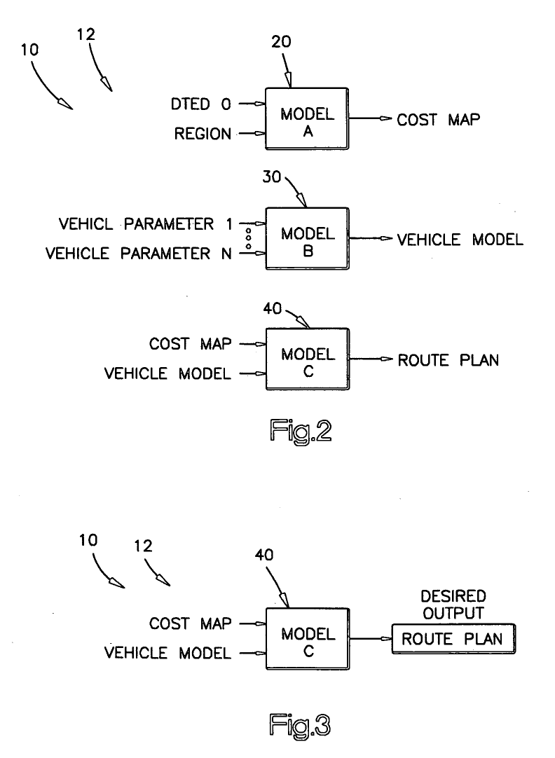

The module library may provide a variety of modules having definitive inputs and outputs. For a planning agent 12 of the example system 10, as shown in FIG. 2, a first module (Module A) 20 may accept terrain data (e.g., DTED level 0) and a region as input and produce a cost map as output. A second module (Module B) 30 may accept various vehicle parameters as input and produce a vehicle model as output. A third module (Module C) 40 may accept the cost map and vehicle model output (from the first and second modules 20, 30) and produce a route plan as the desired output of the planning agent 12 (FIG. 3).

In addition, the modules 20, 30, 40 may have definitive characteristics of functionality and performance (e.g., performance time). For example, the performance time for Module A 20 is likely to vary with the area of the region. Thus, Module A 20 may have a timing characteristic of α*Δx*αy, where α is a constant.

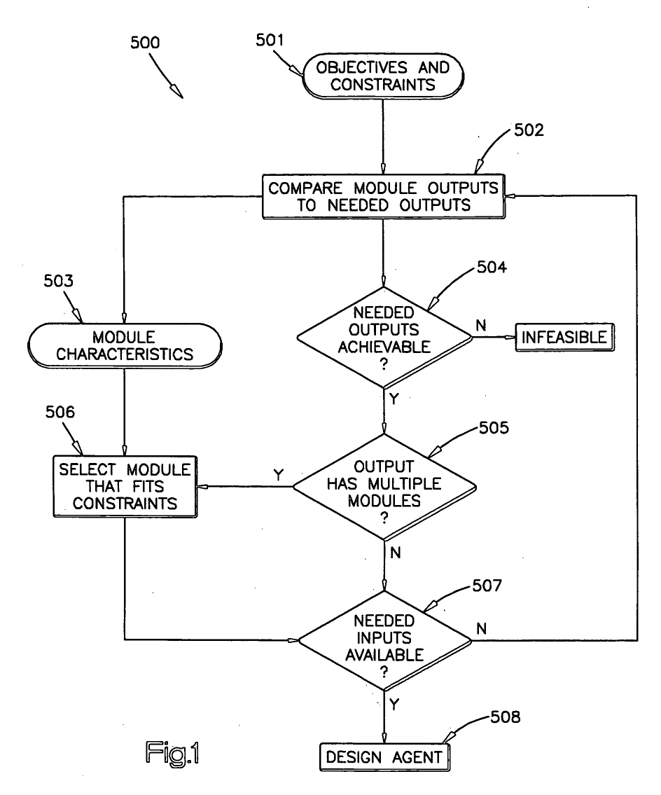

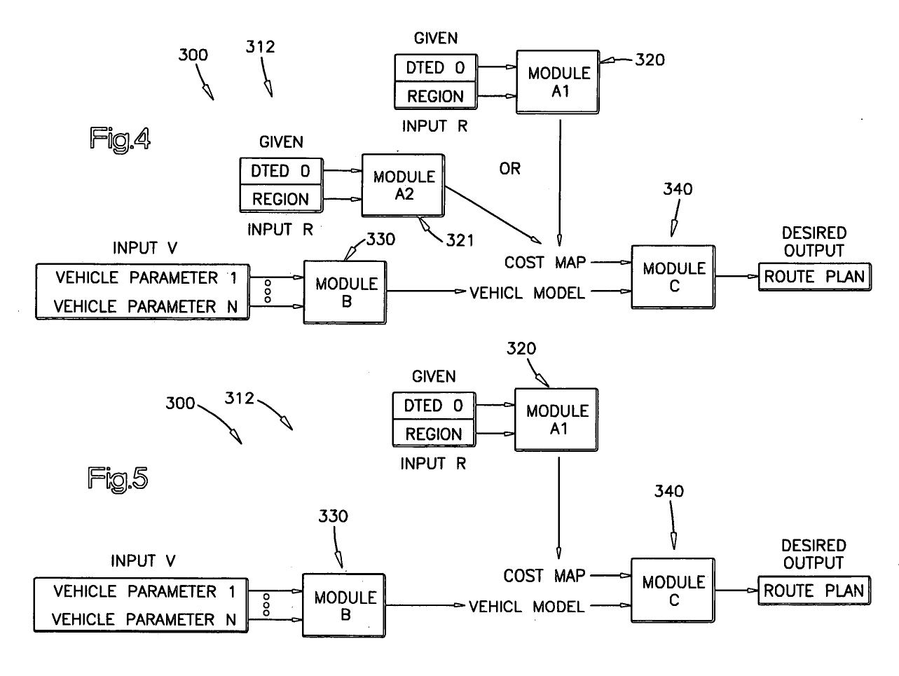

A shown in FIG. 4, multiple modules may be capable of completing a single task. The example Module A 20 of FIG. 1 may comprise Module A1 320 of the planning agent 320 of the system 300. In addition, Module A2 321 may exist for which the timing characteristic is (α*Δx)*(β*αy), where α and β are constants. The objectives and constraints of the planning agent 320 may also be a required starting condition.

For example, an objective of the planning agent 312 may be the generation of a minimal cost route plan from point A to point B within region R (└X_{A}:X_{B}┘└Y_{A}:Y_{B}┘), for which DTED 0 is provided, for a vehicle with parameters V with the constraint of completion in T seconds.

Given these initial conditions, the planning agent 312 may calculate an objective output. The output may be a route plan. The system 300 may determine which modules may be available to produce the route plan. The system 300 may determine that not Module A1 320, not Module A2 321, not Module B 330, but Module C 340 produces a route plan (FIG. 4).

Next, the system 300 may evaluate inputs to a module or modules. Cost Map and Vehicle Model may be input to Model C 340. Are Cost Map and Vehicle Model available? If not, what modules are available that can produce these as outputs? Modules A1 and A2 320, 321 may each produce Cost Map and Module B 330 may produce Vehicle Model.

Since multiple modules may produce the cost map, which module should be used? The system 300 may determine the module that better satisfies the constraints. Given the Δx and Δy of R, processing times may be estimated given timing characteristics of Module A1 320 and Module A2 321. If A1 timing is less than T and A2 timing is greater than T, the system 300 may determine that Module A1 320 should be used (FIG. 5). If all required inputs are available, the system 300 may design the planning agent 312.

The system 300 may alternatively design module characteristics in a more complex manner. For example, rather than only time being a dependent variable, some measure of accuracy may also be a dependent variable. Module C 340 may be able to determine very simple, but costly, routes (e.g., a straight line) in very little time, but another module may determine low cost routes in large amounts of time. In this case, a characteristic function may be two-dimensional. In general, this may be N-dimensional, and there may be multiple functions.

In addition, objectives and constraints may be defined in a complex manner. For example, an objective may be to minimize cost and time, rather than merely constrain the time. In this case, there may be an objective function with which the system 300 may form a feasibility decision surface, e.g., minimize

$${\sum }_{i} {w}_{i} {P}_{i}$$

where ω are weights and P are decision criteria. In this case, a selection step may be based on which module best fits the objective function.

Planning agents of the system 300, designed on an ad-hoc basis, may be more flexible than pre-programmed agents. Pre-programmed modules 320, 321, 330, 340 that perform basic tasks form the building blocks for these ad-hoc planning agents rather than entire agents being pre-programmed. These ad-hoc planning agents 312 may perform as a single pre-programmed agent if they use an a priori script (e.g., a script that defines the module composition of the planning agent rather than dynamically determining the composition would behave identically but the script would save time because of the predefinition).

However, ad hoc planning agents 312 of the system 300 offer the advantage of being designed in situ, based on current conditions, objectives, and constraints. Such planning agents 312 offer superior performance to pre-programmed planning agents in rapidly changing environments.

FIG. 1 represents an example system 500 designing a planning agent. Box 501 represents objectives and constraints input to the system 500. In box 502, the system 500 compares module outputs. From box 502, the system 500 proceeds to box 503 and box 504.

In box 503, the system 500 reviews characteristics of the modules from a module library. In box 504, the system 500 determines whether needed outputs are available. If the needed outputs are not available, a planning agent may not be designed to achieve the desired output. If needed outputs are available, the system 500 proceeds to box 505.

In box 505, the system 500 determines whether and which outputs have multiple modules. If no outputs have multiple modules, the system 500 proceeds to box 507. If one or more outputs have multiple modules, the system 500 proceeds to box 506. In box 506, the system 500 selects a module that best fits the objectives and constraints 501. From box 506, the system 500 proceeds to box 507.

In box 507, the system 500 determines whether the necessary inputs are available. If the necessary inputs are not available, the system 500 proceeds back to box 502. If the necessary inputs are available, the system 500 proceeds to box 508 with the optimum planning agent.

As shown in FIGS. 1 and 2, an example system 500 automatically designs a software component to perform a defined task having task inputs 501 and task outputs 508. The example system 500 includes a plurality of modules 20, 30, 40 having module inputs and module outputs, a first comparator 502, 504, 505, a selector 506, and a second comparator 507. A first part 502 of the first comparator compares the module outputs to the task outputs. A second part 504 of the first comparator determines whether the task outputs are achievable by the plurality of modules 20, 30, 40. A third part 505 of the first comparator determines whether at least two of the plurality of modules 20, 30, 40 satisfy one of the task outputs.

The selector 506 selects a preferred module from the at least two of the plurality of modules 20, 30, 40. The second comparator 507 compares at least one of the task inputs to inputs of the preferred module. The second comparator 507 determines whether the inputs of the preferred module are included within the task inputs. The first part 502 of the first comparator receives inputs of the preferred module, not included within the task inputs, from the second comparator 507.

The task inputs may include objectives 501 of the defined task. The task inputs include constraints 501 of the software component. The module inputs and the module outputs may represent characteristics of the plurality of modules 20, 30, 40. The characteristics may be stored in a module library 503.

The second comparator 507 outputs the software component 508 for performing the defined task. The first comparator 502, 504, 505 and the second comparator 507 may comprise the same component. The first comparator 502, 504, 505 and the selector 506 may comprise the same component. The first comparator 502, 504, 505, the selector 506, and the second comparator 507 may comprise the same component.

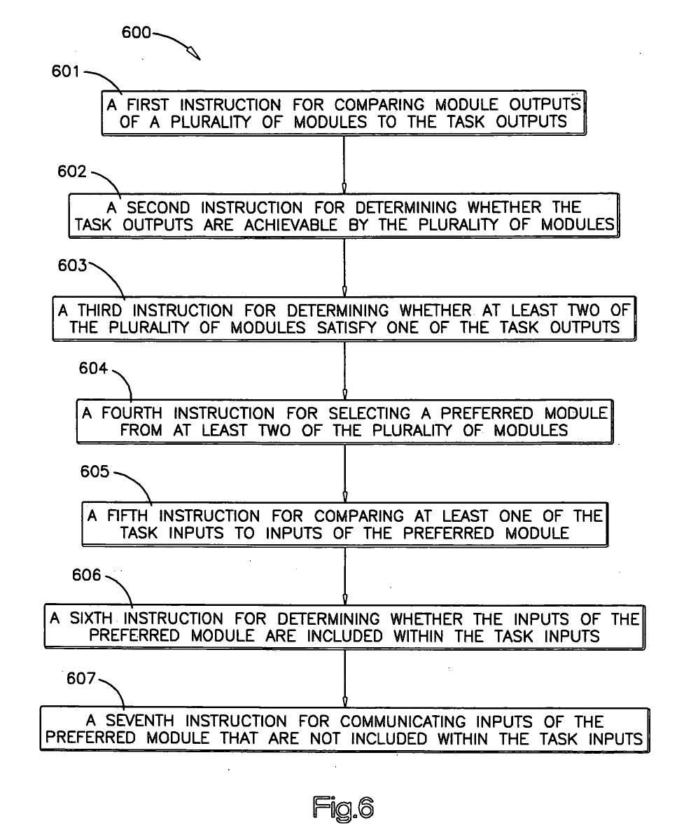

As shown in FIG. 6, an example computer program product 600 automatically designs a software component to perform a defined task having task inputs and task outputs. The example computer program product 600 includes a first instruction 601 for comparing module outputs of a plurality of modules 20, 30, 40 to the task outputs; a second instruction 602 for determining whether the task outputs are achievable by the plurality of modules 20, 30, 40; a third instruction 603 for determining whether at least two of the plurality of modules 20, 30, 40 satisfy one of the task outputs; a fourth instruction 604 for selecting a preferred module from the at least two of the plurality of modules; a fifth instruction 605 for comparing at least one of the task inputs to inputs of the preferred module; a sixth instruction 606 for determining whether the inputs of the preferred module are included within the task inputs; and a seventh instruction 607 for communicating inputs of the preferred module that are not included within the task inputs.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for automatically designing a software component to perform a defined task having task inputs and task outputs, said system comprising:
a plurality of modules having module inputs and module outputs;
a first comparator for comparing the module outputs to the task outputs, said first comparator determining whether the task outputs are achievable by said plurality of modules, said first comparator determining whether at least two of said plurality of modules satisfy one of the task outputs;
a selector for selecting a preferred module from said at least two of said plurality of modules; and
a second comparator for comparing at least one of the task inputs to inputs of said preferred module, said second comparator determining whether the inputs of said preferred module are included within the task inputs,
said first comparator receiving inputs of said preferred module that are not included within the task inputs.

2. The system as set forth in claim 1 wherein the task inputs include objectives of the defined task.

3. The system as set forth in claim 1 wherein the task inputs include constraints of the software component.

4. The system as set forth in claim 1 wherein said module inputs and said module outputs represent characteristics of said plurality of modules.

5. The system as set forth in claim 4 wherein said characteristics are stored in a module library.

6. The system as set forth in claim 1 wherein said second comparator outputs the software component for performing the defined task.

7. The system as set forth in claim 1 wherein said first comparator and said second comparator comprise the same component.

8. The system as set forth in claim 1 wherein said first comparator and said selector comprise the same component.

9. The system as set forth in claim 1 wherein said first comparator, said selector, and said second comparator comprise the same component.

10. The system as set forth in claim 1 wherein said first comparator receives inputs of said preferred module from said second comparator.

11. A computer program product for automatically designing a software component to perform a defined task having task inputs and task outputs, said computer program product comprising:
a first instruction for comparing module outputs of a plurality of modules to the task outputs;
a second instruction for determining whether the task outputs are achievable by the plurality of modules;
a third instruction for determining whether at least two of the plurality of modules satisfy one of the task outputs;
a fourth instruction for selecting a preferred module from the at least two of the plurality of modules;
a fifth instruction for comparing at least one of the task inputs to inputs of the preferred module;
a sixth instruction for determining whether the inputs of the preferred module are included within the task inputs; and
a seventh instruction for communicating inputs of the preferred module that are not included within the task inputs.

12. The computer program product as set forth in claim 11 wherein the task inputs include objectives of the defined task.

13. The computer program product as set forth in claim 12 wherein the task inputs include constraints of the software component.

14. The computer program product as set forth in claim 13 wherein the outputs of the plurality of modules represent characteristics of the plurality of modules.

15. The computer program product as set forth in claim 14 wherein the characteristics are stored in a module library.

16. The computer program product as set forth in claim 15 further including an eighth instruction for producing a software component for performing the defined task.

17. The computer program product as set forth in claim 16 wherein said first and fifth instructions are performed by a single component.

18. The computer program product as set forth in claim 16 wherein said first and fourth instructions are performed by a single component.

19. The computer program product as set forth in claim 16 wherein said first, fourth, and fifth instructions are performed by a single component.

20. A method for automatically designing a software component to perform a defined task having task inputs and task outputs, said method comprising the steps of:
comparing module outputs of a plurality of modules to the task outputs;
determining whether the task outputs are achievable by the plurality of modules;
determining whether at least two of the plurality of modules satisfy one of the task outputs;
selecting a preferred module from the at least two of the plurality of modules;
comparing at least one of the task inputs to inputs of the preferred module;
determining whether the inputs of the preferred module are included within the task inputs; and
communicating inputs of the preferred module that are not included within the task inputs.
